(19) United States
(12) Patent Application Publication
(10) Pub. No.: US 2015/0091980 A1
(43) Pub. Date: Apr. 2, 2015

(54) RECORDING-HEAD RECOVERY SYSTEM, INK-JET RECORDING APPARATUS INCLUDING THE SAME, AND RECORDING-HEAD RECOVERY METHOD

(71) Applicant: KYOCERA Document Solutions Inc., Osaka (JP)

(72) Inventor: Yasutaka INUI, Osaka (JP)

(73) Assignee: KYOCERA Document Solutions Inc., Osaka (JP)

(21) Appl. No.: 14/490,201

(22) Filed: Sep. 18, 2014

(30) Foreign Application Priority Data
Sep. 30, 2013 (JP) 2013-203904
Sep. 30, 2013 (JP) 2013-203909
Jun. 3, 2014 (JP) 2014-114784
Jun. 3, 2014 (JP) 2014-114786

(51) Int. Cl. B41J 2/165

(52) U.S. Cl. CPC B41J 2/16544; B41J 2/1652
USPC 347/33

(57) ABSTRACT

A recording-head recovery system includes a wiper, a drive mechanism, and a control portion. The control portion is capable of performing a recording-head recovery operation which performs successively: a purged ink placing operation in which ink is forcibly pushed out of a ejecting nozzle and the purged ink is placed onto a nozzle region; a ejecting wipe operation in which the purged ink is wiped away by moving the wiper along an ink ejecting surface, applying and spreading the ink over the ink ejecting surface by ejecting the ink from an ejecting nozzle in synchronization with timing when the wiper is passing the nozzle region; and a ejected ink wiping operation in which the ejected ink applied and spread over the ink ejecting surface is wiped away.

### INCORPORATION BY REFERENCE

This application is based on and claims the benefit of priority from Japanese Patent Application No. 2013-203904 (filed on Sep. 30, 2013), Japanese Patent Application No. 2013-203909 (filed on Sep. 30, 2013), Japanese Patent Application No. 2014-114784 (filed on Jun. 3, 2014), and Japanese Patent Application No. 2014-114786 (filed on Jun. 3, 2014), the contents of which are hereby incorporated by reference.

### BACKGROUND OF THE INVENTION

The present disclosure relates to an ink-jet recording apparatus that performs recording by ejecting ink onto a recoding medium such as a paper sheet and the like, more particularly, to a recording-head recovery system that forcibly ejects ink from a nozzle of a recording head, thereafter, wipes away ink adhering to an ink ejecting surface by means of a wiper.

Recording apparatuses such as facsimiles, copy machines, printers and the like are structured to record an image onto recording mediums such as paper sheets, OHP sheets and the like, and depending on recording types, can be classified into an ink-jet type, a wire dot type, a thermal type and the like. Besides, the ink-jet recording type can be classified into a serial type in which a recording head scans a recording medium to perform recording and a line head type which performs recording by means of a recording head that is fixed to an apparatus main body.

An ink-jet recording apparatus of the line head type includes ink-jet heads (recording heads) of the line head type for every color in which ejecting nozzles are arranged at predetermined intervals across an entirety of a printing regional width perpendicular to a conveyance direction of a recording medium. And, by ejecting ink from an ejecting nozzle corresponding to a printing position in synchronization with conveyance of the recording medium, it is possible to perform printing over the entire recording medium.

In such an ink-jet recording apparatus, there is a case where deterioration in straight traveling of ink (bent flying), defective ejecting and the like occur and printing performance of the recoding head declines. A conceivable reason for this is meniscus trouble, in which foreign matter such as dirt, dust, paper powder occurring during paper-sheet conveyance and the like, minuscule ink drips (hereinafter, called a mist) ejected together with ink drops for image recording, and bouncing mists occurring when ink drops adhere to the recording medium adhere to the ink ejecting surface of the recording head. Besides, a sealability decline during a cap mounted time, which is caused by mists adhering to a cap mounting place and drying, and viscosity increase of the ink in the nozzle due to the sealability decline are also conceivable.

Because of this, to prevent: ink drying in the ink ejecting nozzle whose ink ejecting surface of the recording head is provided with an opening; and nozzle clogging caused by the thickening ink in the ink ejecting nozzle, a method is used, in which the ink is forcibly pushed out (purged) from the nozzle; thereafter, the ink adhering to the ink ejecting surface (nozzle surface) is wiped away by means of a blade-like wiper to perform a recording-head recovery process. However, it is hard to remove high-viscosity ink and dried mists by means of the simple purge operation and wiping operation only. Especially, as the ink contains more solid content, the ink viscosity tends to increase and the wiping by means of the wiper becomes harder.

Because of this, various methods for effectively removing the ink on the ink ejecting surface are proposed, and for example, an ink-jet head cleaning apparatus including a suction nozzle is known, which includes: an ink-repellant surface; an ink-affinity surface that is recessed with respect to the ink-repellant surface and has an ink contact angle smaller than the ink-repellant surface; and a plurality of suction openings formed through the ink-affinity surface.

Besides, an image forming apparatus of the ink-jet type is known, which includes an applying member that has a reception portion for receiving ink ejected from an ink ejecting device, applies the ink onto the ink ejecting surface by means of the reception portion coming into contact with the ink ejecting surface and moving, wherein the image forming apparatus executes a step for placing the ink onto the reception portion of the applying portion, a step for applying the ink placed on the reception portion onto the ink ejecting surface, and a step for wiping the ink ejecting surface, on which the ink is applied, by means of a wiping member.

Further, an ink-jet recording apparatus is known, in which an ink drop is not ejected from a nozzle and ink flooding is formed around the nozzle by applying a drive voltage to make the ink flood onto a nozzle surface; thereafter, the nozzle surface is wiped, whereby the nozzle surface is prevented from being damaged.

### SUMMARY OF THE INVENTION

A recording-head recovery system according to an aspect of the present disclosure is a recording-head recovery system that includes a wiper, a drive mechanism, and a control portion, wherein the recording head is provided with a nozzle region to which an ejecting nozzle for ejecting ink onto a recording medium is opened. The wiper is pushed against a wiping start position outside the nozzle region. The drive mechanism reciprocates the wiper along an ink ejecting surface. The control portion controls pushing-out and ejecting of ink from the ejecting nozzle and operation of the drive mechanism. The control portion can execute a recording-head recovery operation which performs successively: a purged-ink placing operation in which ink is forcibly pushed out of the ejecting nozzle and the purged ink is placed on the nozzle region; a ejecting wipe operation in which the wiper is moved from the wiping start position along the ink ejecting surface to wipe away the purged ink, and the ink ejecting from the ejecting nozzle is successively performed in synchronization with timing when the wiper passes to apply and spread the ink over the ink ejecting surface; and an ink wiping operation in which the wiper is moved along the ink ejecting surface to wipe away the ink applied and spread on the ink ejecting surface.

Still other objects of the present disclosure and specific advantages obtained by the present disclosure will become more apparent from the following description of embodiments described hereinafter.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a schematic structure of an ink-jet recording apparatus according to the present disclosure.

FIG. 2 is a view when seeing, from above, a first conveyance unit and recording portion of the ink-jet recording apparatus shown in FIG. 1.

FIG. 3 is a view when seeing a recording portion from obliquely above.

FIG. 4 is a view of a recording head that composes a line head of a recording portion.

FIG. 5 is a view when seeing a recording head from a side of an ink ejecting surface.

FIG. 6 is a view showing a structure of a dot forming portion of a recording head.

FIG. 7 is a view showing an ink flow path from an ink tank to a recording head of an ink-jet recording apparatus according to the present disclosure.

FIG. 8 is a view when seeing, from obliquely above, a wiping mechanism incorporated in a maintenance unit.

FIG. 9 is a view when seeing, from obliquely above, a carriage that composes a wiping mechanism.

FIG. 10 is a view when seeing, from obliquely above, a support frame that composes a wiping mechanism.

FIG. 11 is a view showing a state where a wiping mechanism is removed from a unit housing of a maintenance unit.

FIG. 12 is a view of a moving-up/down mechanism disposed in a unit housing and a view showing a state where a lift member is in a horizontal state.

FIG. 13 is a view of a moving-up/down mechanism disposed in a unit housing and a view showing a state where the lift member rises from the state of FIG. 12.

FIG. 14 is a view of the lift member that composes a moving-up/down mechanism.

FIG. 15 is a view showing a state where the maintenance unit is disposed under the recording portion.

FIG. 16 is a view showing a carriage, a wiper, a support frame, and a moving-up/down mechanism in the maintenance unit in the state of FIG. 15.

FIG. 17 is a view showing a state where the support frame and the carriage ascend by means of the moving-up/down mechanism from the state of FIG. 16 and the wiper is positioned apart from an ink ejecting surface over a predetermined distance.

FIG. 18 is a view showing a state where ink is pushed out of a recording head with a wiper positioned to oppose a vicinity of an end portion of a nozzle region.

FIG. 19 is a view when seeing, from a side of an ink ejecting surface, a state where ink is pushed out of a recording head with a wiper positioned to oppose a vicinity of an end portion of a nozzle region.

FIG. 20 is a view around an ink ejecting nozzle which a wiper is passing during a recovery operation of a recording head according to a first embodiment.

FIG. 21 is a view showing an operation in which ink is ejected from the ink ejecting nozzle which the wiper is passing in FIG. 20.

FIG. 22 is a view showing a state where a wiper is moved to a downstream-side end edge of a recording head in a first direction.

FIG. 23 is a view when seeing, from a side of an ink ejecting surface, a state where a wiper is moved to a downstream-side end edge of a recording head in a first direction.

FIG. 24 is a view showing a state where the wiper is moved from the state of FIG. 22 in a second direction to wipe away ink on an ink ejecting surface.

FIG. 25 is a view showing a state where a support frame and a carriage descend by means of a moving-up/down mechanism and a wiper is positioned apart from an ink ejecting surface.

FIG. 26 is a view around an ink ejecting nozzle which a wiper is passing during a recovery operation of a recording head according to a second embodiment.

FIG. 27 is a view showing an operation in which ink is pushed out of the ink ejecting nozzle which the wiper is passing in FIG. 26.

### DETAILED DESCRIPTION OF THE EMBODIMENTS

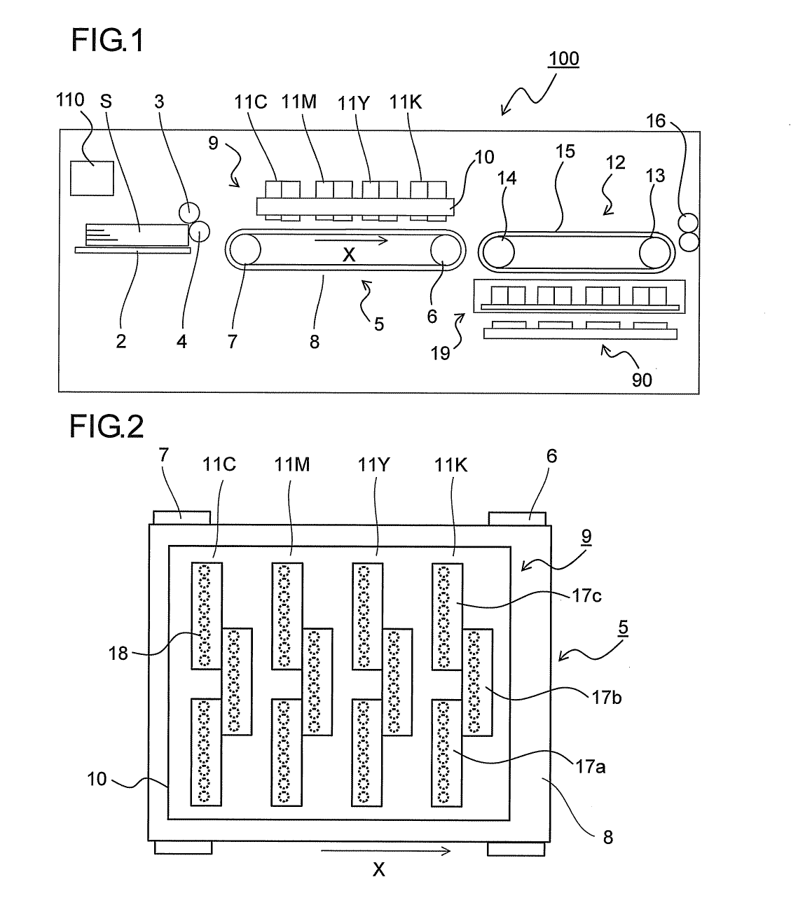

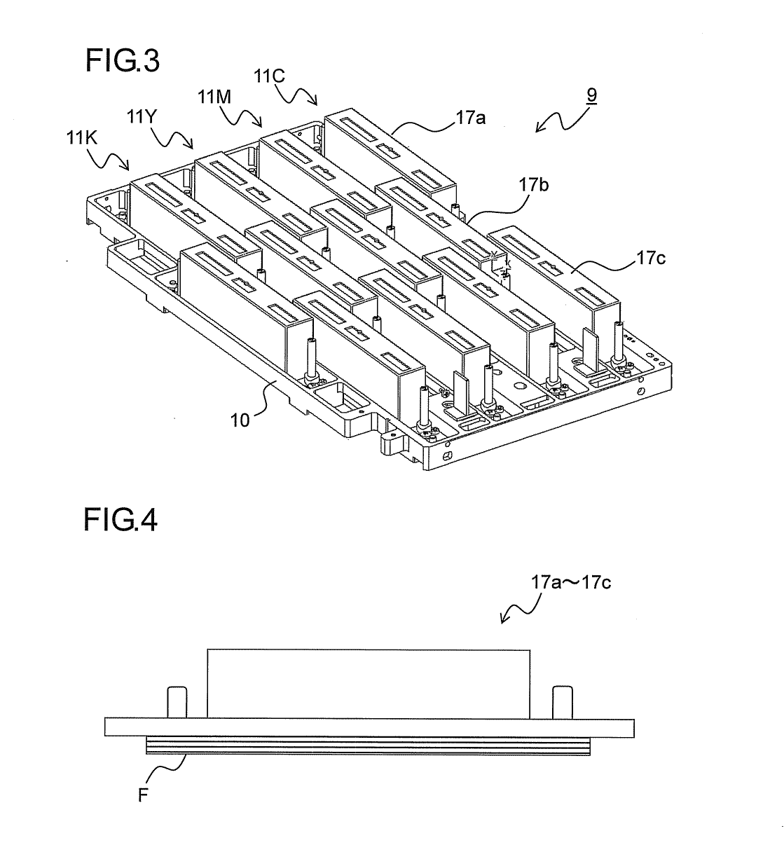

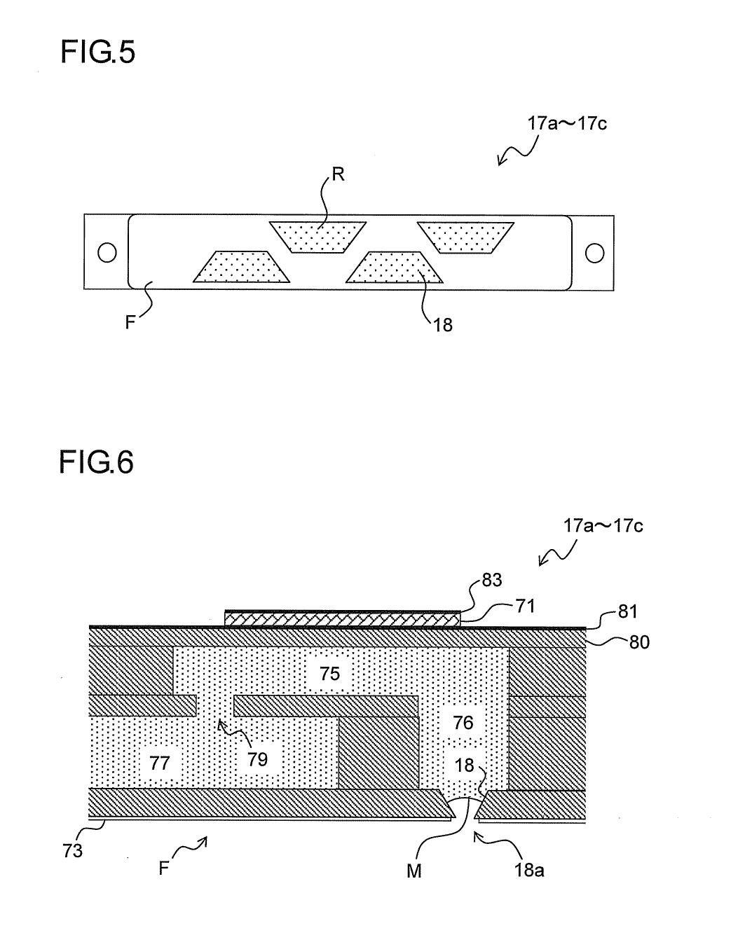

Hereinafter, embodiments of the present disclosure are described with reference to the drawings. FIG. 1 is a view showing a structure of an ink-jet recording apparatus 100 according to an embodiment of the present disclosure, FIG. 2 is a view when seeing, from above, a first conveyance unit 5 and recording portion 9 of the ink-jet recording apparatus 100 shown in FIG. 1, FIG. 3 is a view when seeing the recording portion 9 from obliquely above, FIG. 4 is a view of recording heads 17a-17c that compose the line heads 11C-11K of the recording portion 9, FIG. 5 is a view when seeing the recording heads 17a-17c from a side of an ink ejecting surface F, and FIG. 6 is a view showing a structure of a dot forming portion of the recording heads 17a-17c. In the meantime, FIG. 3 shows a state when seeing the recording portion 9 from behind FIG. 1 (upper side of FIG. 2), in which arrangement of the line heads 11C-11K is opposite to FIG. 1 and FIG. 2. Besides, the recording heads 17a-17c has the same shape and structure as each other; accordingly, FIG. 4-FIG. 6 use one view to show the recording heads 17a-17c.

As shown in FIG. 1, a paper-sheet supply tray 2 for storing paper sheets S as a recording medium disposed in a left side portion of the ink-jet recording apparatus 100, and one end portion of the paper-sheet supply tray 2 is provided with: a paper-sheet supply roller 3 for successively conveying and supplying the paper sheets S one after another to a first conveyance unit 5 beginning with the uppermost paper sheet S; and a driven roller 4 that is pushed against the paper-sheet supply roller 3 to be driven to rotate.

The first conveyance unit 5 and the recording portion 9 are disposed in a downstream side (right side of FIG. 1) with respect to the paper-sheet supply roller 3 and driven roller 4 in a paper-sheet conveyance direction (arrow X direction). The first conveyance unit 5 has a structure that includes: a first drive roller 6 disposed in a downstream side in the paper-sheet conveyance direction; a first driven roller 7 disposed in an upstream side in the paper-sheet conveyance direction; and a first conveyance belt 8 mounted on the first drive roller 6 and the first driven roller 7, wherein the first drive roller 6 is driven to rotate in a clockwise direction by a control signal from a control portion 110 of the ink-jet recording apparatus 100, whereby the paper sheet S held by the first conveyance belt 8 is conveyed in the arrow X direction.

Here, by disposing the first drive roller 6 in the downstream side in the paper-sheet conveyance direction, a conveyance surface (upper surface in FIG. 1) of the first conveyance belt 8 is tensioned by the first drive roller 6; accordingly, it is possible to raise tension of the conveyance surface of the first conveyance belt 8 and stable conveyance of the paper sheet S becomes possible. In the meantime, a dielectric-resin sheet is used for the first conveyance belt 8 and a belt having no seam (seamless) is mainly used.

The recording portion 9 includes a head housing 10, the line heads 11C, 11M, 11Y, and 11K that are held by the head housing 10. These line heads 11C-11K are supported at a height to form a predetermined distance (e.g., 1 mm) from the conveyance surface of the first conveyance belt 8, and as shown in FIG. 2, the plurality of recording heads 17a-17c (here, three) are arranged in a zigzag pattern along a paper-sheet width direction (vertical direction of FIG. 2) perpendicular to the paper-sheet conveyance direction. The line heads 11C-11K each have a recording region wider than the maximum width of the carried paper sheet S, and are able to eject ink from an ink ejecting nozzle 18 corresponding to a printing position to the paper sheet S that is conveyed on the first conveyance belt 8.

As shown in FIG. 4 and FIG. 5, the ink ejecting surface F of the recording heads 17a-17c is provided with nozzle regions R where many ink ejecting nozzles 18 are arranged. Besides, as shown in FIG. 2 and FIG. 3, as to the three recording heads 17a-17c composing the same line heads 11C-11K, end portions are disposed to overlap each other such that part of the ink ejecting nozzles 18 disposed on each of the recording heads 17a-17c overlap each other in the paper-sheet conveyance direction.

As shown in FIG. 6, the ink ejecting surface F of the recording heads 17a-17c is provided with a plurality of ink ejecting openings 18a having minuscule diameters as opening portions of the ink ejecting nozzles 18 across a maximum width of at least a printing region in a longitudinal direction (main scan direction) of the ink ejecting surface F.

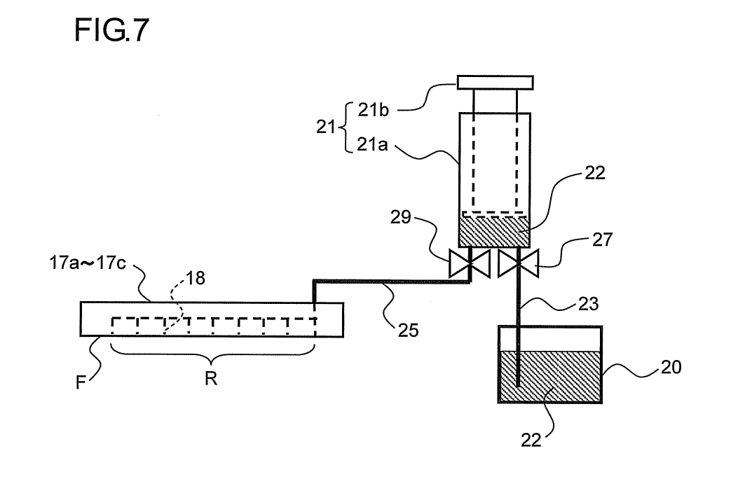

Besides, the recording heads 17a-17c include: a water-repellant film 73 that covers a portion other than the ejecting openings 18a of the ink ejecting surface F; pressurization chambers 75 that are disposed one for every ejecting opening 18a; nozzle flow paths 76 that connect the pressurization chambers 75 and the ink ejecting nozzles 18 to each other; and common flow paths 77 that supply ink from an ink tank 20 (see FIG. 7) storing the ink to the plurality of pressurization chambers 75. The pressurization chamber 75 and the common flow path 77 are connected to each other via a supply hole 79, and ink is supplied from the common flow path 77 to the pressurization chamber 75 via the supply hole 79. The ink ejecting nozzle 18 is continuous from the pressurization chamber 75 to the ejecting opening 18a via the nozzle flow path 76. Of walls of the pressurization chamber 75, a wall opposite to the ink ejecting surface F is composed of a diaphragm 80. The diaphragm 80 is formed continuously over the plurality of pressurization chambers 75, and a common electrode 81, which is likewise formed continuously over the plurality of pressurization chambers 75, is laminated on the diaphragm 80. On the common electrode 81, separate piezoelectric elements 71 are disposed for every pressurization chambers 75, and separate individual electrodes 83 are disposed for every pressurization chambers 75 to cooperate with the common electrodes 81 to sandwich the piezoelectric element 71.

A drive pulse generated by a drive pulse generation portion (not shown) of a head drive portion is applied to the individual electrode 83, whereby each piezoelectric element 71 is individually driven. Deformation of the piezoelectric element 71 due to the driving is conducted to the diaphragm 80, and deformation of the diaphragm 80 compresses the pressurization chamber 75. As a result of this, a pressure acts on the ink in the pressurization chamber 75, so that the ink, which passes through the nozzle flow path 76 and the ink ejecting nozzle 18, turns into ink drops and are ejected from the ejecting opening 18a onto a paper sheet (image forming operation). In the meantime, even during a period when no ink drops are ejected ink is stored in the ink ejecting nozzle 18 and the ink forms a meniscus surface M in the ink ejecting nozzle 18.

As to the recording heads 17a-17c that compose each of the line heads 11C-11K, four color (cyan, magenta, yellow, and black) inks stored in the respective ink tanks 20 (see FIG. 7) are supplied to the respective line heads 11C-11K.

By means of the control signal from the control portion 110 (see FIG. 1), each of the recording heads 17a-17c ejects ink onto the paper sheet S, which is held and conveyed by the conveyance surface of the first conveyance belt 8, in accordance with image data received from an external computer and the like. In this way, a color image, in which the four color inks of cyan, magenta, yellow, and black are superimposed, is formed on the paper sheet S on the first conveyance belt 8.

Besides, to prevent defective ink ejecting due to drying and clogging of the recording heads 17a-17c, a purge operation of pushing out the ink from the ink ejecting nozzles 18 of all the recording heads 17a-17c is performed at a printing start time after a long-time suspension, and between printing operations, a blank operation, which ejects high-viscosity ink in the nozzle from the ink ejecting nozzles 18 of the recording heads 17a-17c whose ink ejecting amount is smaller than a predetermined value, is performed to be ready for the next printing operation.

In the meantime, as methods for ejecting the ink from the recording heads 17a-17c, it is possible to use various methods such as a piezoelectric method that uses a not-shown piezoelectric element to push out ink, a thermal ink-jet method that generates an air bubble by means of a heat generating body and exerts a pressure to eject ink, and the like.

Back to FIG. 1, a second conveyance unit 12 is disposed in a downstream side (right side of FIG. 1) with respect to the first conveyance unit 5 in the paper-sheet conveyance direction. The second conveyance unit 12 has a structure that includes: a second drive roller 13 disposed in a downstream side in the paper-sheet conveyance direction; a second driven roller 14 disposed in an upstream side; and a second conveyance belt 15 mounted on the second drive roller 13 and the second driven roller 14, wherein the second drive roller 13 is driven to rotate in a clockwise direction, whereby the paper sheet S held by the second conveyance belt 15 is conveyed in the arrow X direction.

The paper sheet S, on which an ink image is recorded by the recording portion 9, is conveyed from the first conveyance unit 5 to the second conveyance unit 12, and the ink ejected to the surface of the paper sheet S is dried during passing through the second conveyance unit 12. Besides, a maintenance unit 19 and a cap unit 90 are disposed under the second conveyance unit 12. The maintenance unit 19 moves under the recording unit 9 when performing the above purge, wipes away the ink pushed out of the ink ejecting nozzles 18 of the recording heads 17a-17c, and collects the ink wiped away. The cap unit 90 moves horizontally under the recording portion 9 when capping the ink ejecting surface F (see FIG. 4) of the recording heads 17a-17c, further moves upward to be mounted onto lower surfaces of the recording heads 17a-17c. In the meantime, a detailed structure of the maintenance unit 19 is described later.

Besides, a pair of ejection rollers 16, which eject paper sheet S on which the image is recorded to outside of the apparatus main body, is disposed in a downstream side with respect to the second conveyance unit 12 in the paper-sheet conveyance direction, and an ejection tray (not shown), in which the paper sheet S ejected to the outside of the apparatus main body is loaded, is disposed in a downstream side with respect the pair of ejection rollers 16.

Next, ink supply from the ink tank 20 to the recording heads 17a-17c during the printing period, and ink pushing-out from the recording heads 17a-17c during the purge period are described. FIG. 7 is a view showing an ink flow path from the ink tank 20 to the recording heads 17a-17c of the ink-jet recording apparatus 100 according to the present disclosure. In the meantime, the ink flow path shown in FIG. 7 is disposed between each color ink tank 20 and each set of the recording heads 17a-17c; however, here, the ink flow path for one arbitrary color is described.

As shown in FIG. 7, a syringe pump 21 is disposed between the ink tank 20 and the recording heads 17a-17c. The ink tank 20 and the syringe pump 21 are connected to each other by means of a first supply path 23 formed of a tube member, while the syringe pump 21 and the common flow path 77 (see FIG. 6) in the recording heads 17a-17c are connected to each other by means of a second supply path 25 formed of a tube member.

The first supply path 23 is provided with a flow-in valve 27, while the second supply path 25 is provided with a flow-out valve 29. By opening and closing the flow-in valve 27, ink movement in the first supply path 23 is allowed or limited, while by opening and closing the flow-out valve 29, ink movement in the second supply path 25 is allowed or limited.

The syringe pump 21 includes a cylinder 21a and a piston 21b. The cylinder 21a is connected to the first supply path 23 and the second supply path 25, and ink 22 in the ink tank 20 flows into the cylinder 21a via the first supply path 23. Besides, ink is discharged from the cylinder 21a via the second supply path 25, the discharged ink is supplied to the recording heads 17a-17c, and ejected from the ink ejecting opening 18a disposed in the nozzle region R of the ink ejecting surface F via the ink ejecting nozzle 18.

The piston 21b is movable up and down by means of a drive apparatus (not shown). A packing (not shown) such as an O-ring or the like is mounted on an outer circumference of the piston 21b, so that it is possible to prevent an ink leak from the cylinder 21a and the piston 21b can slide smoothly along an inner circumferential surface of the cylinder 21a.

During a usual period (printing period), as shown in FIG. 7, both the flow-in valve 27 and the flow-out valve 29 are in the opened state, and by stopping the piston 21b at a predetermined position, a substantially constant amount of ink is stored in the cylinder 21a. And, the ink 22 is supplied from the cylinder 21a to the recording heads 17a-17c by surface tension (meniscus) between the cylinder 21a and the recording heads 17a-17c.

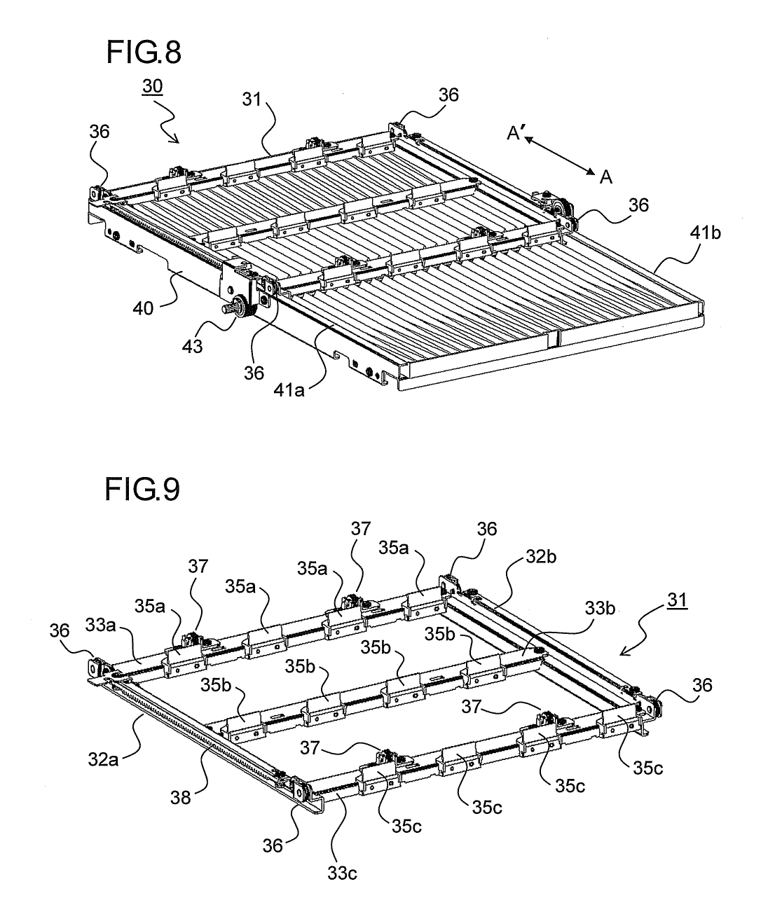

FIG. 8 is a view showing a wiping mechanism 30 incorporated in the maintenance unit 19. The wiping mechanism 30 is composed of a substantially rectangular carriage 31 to which a plurality of wipers 35a-35c (see FIG. 9) are fixed and a support frame 40 that supports the carriage 31. Opposite end edges of an upper surface of the support frame 40 are provided with rail portions 41a, 41b, and slidable rollers 36 disposed at four corners of the carriage 31 come into contact with the rail portions 41a, 41b, whereby the carriage 31 is supported slidably in an arrow AA′ direction by the support frame 40.

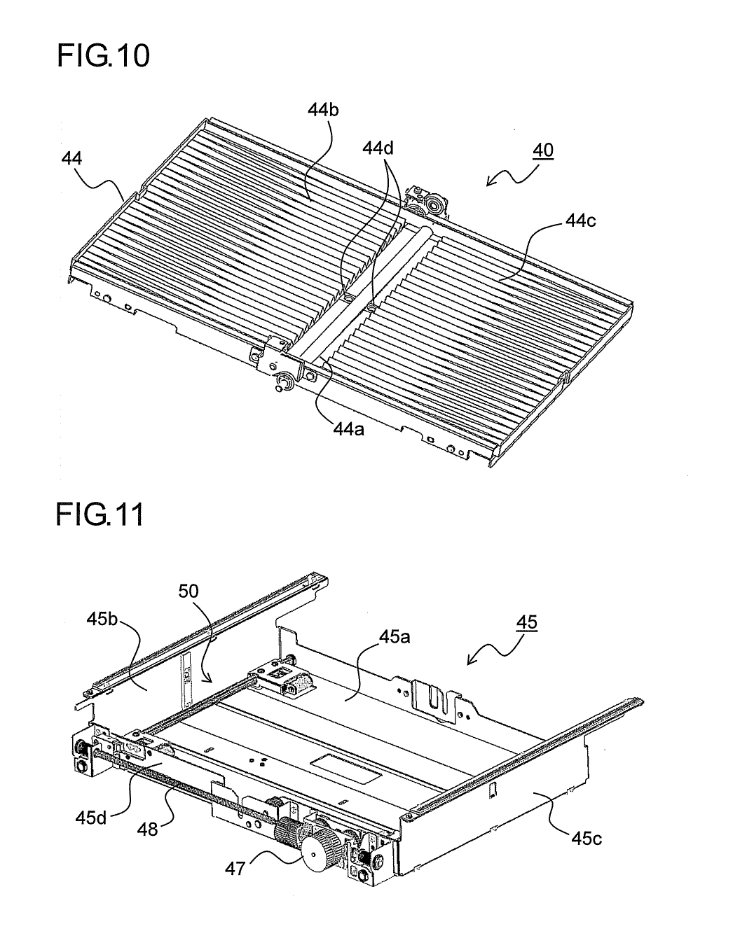

FIG. 9 is a view of the carriage 31 that composes the wiping mechanism 30 shown in FIG. 8, and FIG. 10 is a view of the support frame 40 that composes the wiping mechanism 30 shown in FIG. 8. As shown in FIG. 9, the carriage 31 is formed into a rectangular shape by: first stays 32a, 32b that slidably engage with the rail portions 41a, 41b of the support frame 40 via the slidable rollers 36; and second stays 33a, 33b, and 33c that are fixed like a bridge between the first stays 32a and 32b.

The first stay 32a is provided with rack teeth 38 that mesh with an input gear 43 (see FIG. 8) held by the support frame 40. When the input gear 34 rotates forward and backward, the carriage 31 reciprocates in a horizontal direction (arrow AA direction of FIG. 8) along the support frame 40.

The wipers 35a-35c are members for wiping away the ink pushed out of the ink ejecting nozzles 18 of the respective recording heads 17a-17c. The wipers 35a-35c are pushed, from a substantially vertical direction, against a wiping start position outside the nozzle region R (see FIG. 5) from which a nozzle surface of the ink ejecting nozzle 18 is exposed, and the ink ejecting surface F including the nozzle region R is wiped in a predetermined direction (arrow A direction of FIG. 8) by means of the movement of the carriage 31.

Four wipers 35a are fixed to the second stay 33a at substantially equal intervals, likewise, four wipers 35b are fixed to the second stay 33b at substantially equal intervals, and four wipers 35c are fixed to the second stay 33c at substantially equal intervals. The wipers 35a, 35c are respectively disposed at positions corresponding to the left and right recording heads 17a, 17c (see FIG. 3) that compose each of the line heads 11C-11K. Besides, the wipers 35b are disposed at positions corresponding to the central recording head 17b (see FIG. 3) that composes each of the line heads 11C-11K, and is disposed at a position deviated from the wipers 35a, 35c by a predetermined distance in a direction perpendicular to the moving direction (arrow AA′ direction of FIG. 8) of the carriage 31.

Gap rollers 37 are disposed at four places of upper surfaces of the second stays 33a, 33c. When the wiping mechanism 30 is made to ascend toward the recording portion 9 to perform the wiping operation for the ink ejecting surface F of the recording heads 17a-17c by means of the wipers 35a-35c, the gap roller 37 comes into contact with the head housing 10 of the recording portion 9 to keep constant the contact state between the wipers 35a-35c and the ink ejecting surface F.

As shown in FIG. 10, the upper surface of the support frame 40 is provided with an ink collection tray 44 for collecting the wasted ink that is wiped away from the ink ejecting surface F by the wipers 35a-35c. At a substantially central portion of the ink collection tray 44, a groove portion 44a is formed along an extension direction of the second stays 33a-33c, and tray surfaces 44b, 44c, positioned on both sides of the groove portion 44a have a descending gradient toward the groove portion 44a. The groove portion 44a is provided therein with ink discharging holes 44d, and a bottom surface of the groove portion 44a has a descending gradient toward the ink discharging holes 44d.

The wasted ink, which is wiped away from the ink ejecting surface F by the wipers 35a-35c and falls to the tray surfaces 44b and 44c, is collected in the groove portion 44a, further, flows in the groove portion 44a to the ink discharging holes 44d. Thereafter, the wasted ink is collected by a wasted ink collection tank (not shown) via an ink collection path (not shown) that is connected to the ink discharging holes 44d.

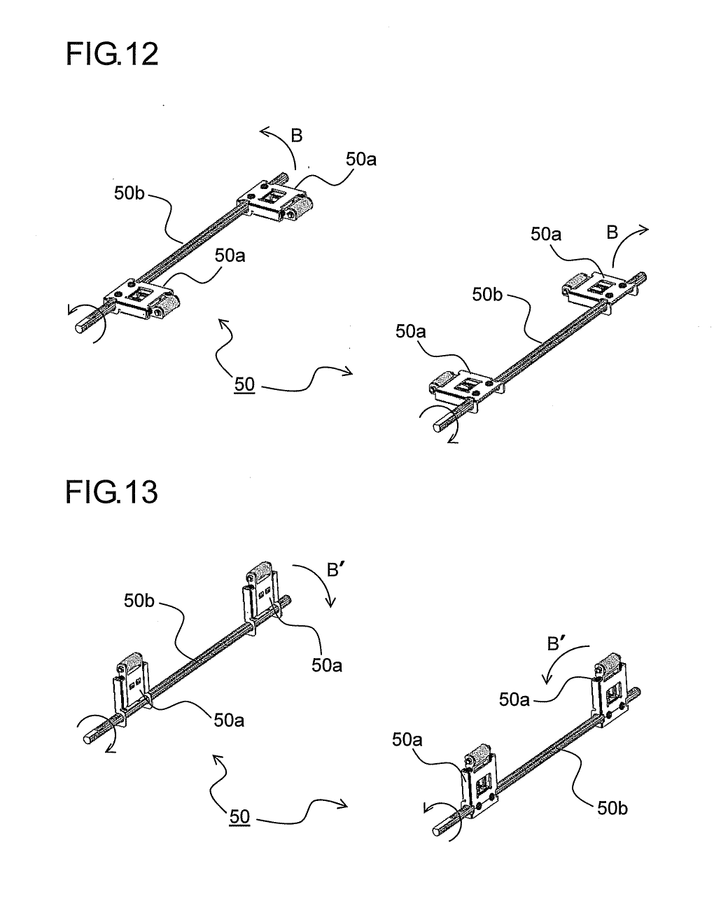

Next, a moving-up/down mechanism 50 for moving up/down the wiping mechanism 30 of the present embodiment is described. FIG. 11 is a view showing a state where the wiping mechanism 30 is removed from a unit housing 45 (disposed under the carriage 31 shown in FIG. 8) of the maintenance unit 19, and FIG. 12 and FIG. 13 are each a view of the moving-up/down mechanism 50 disposed in the unit housing 45. A bottom surface 45a of the unit housing 45 is provided with a pair of the moving-up/down mechanisms 50, in which two lift members 50a are fixed to both ends of a shaft 50b, along side surfaces 45b, 45c that are opposite to each other in the moving direction (arrow AA′ direction of FIG. 8) of the carriage 31. In other words, the moving-up/down mechanism 50 is disposed at positions opposite to both ends (both upper and lower end portions of FIG. 2) in a width direction of the head housing 10 of the recording portion 9. In the meantime, in FIG. 11, the description of the moving-up/down mechanism 50 along the side surface 45c is skipped. Besides, a side surface 45d adjacent to the side surfaces 45b, 45c of the unit housing 45 is provided with a motor 47 and a drive transmission shaft 48 that transmits rotation drive force of the motor 47 to the shaft 50b.

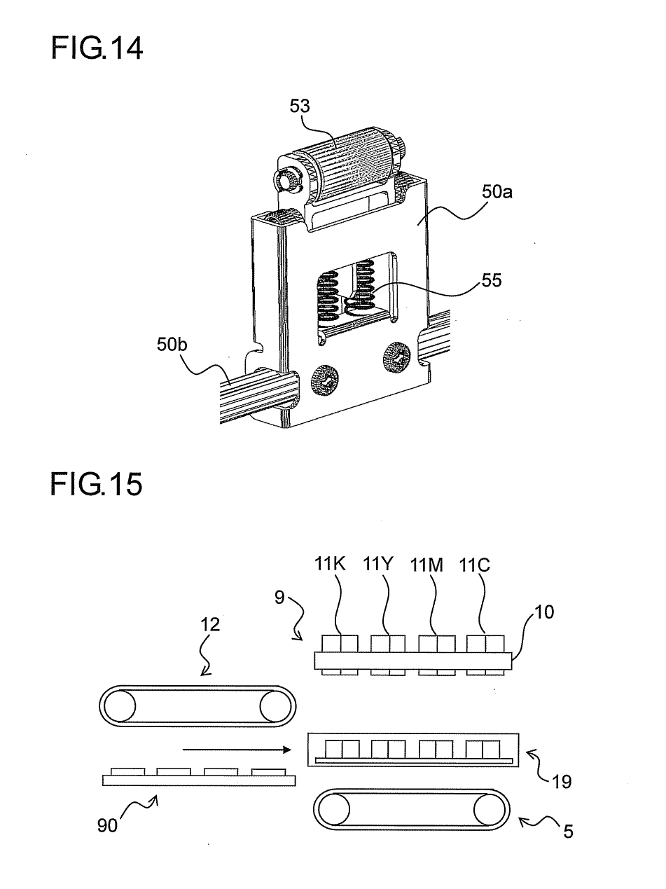

FIG. 14 is a perspective view of the lift member 50a that composes the moving-up/down mechanism 50. A lower end portion of the lift member 50a is fixed to the shaft 50b, while a pushing-up roller 53 is rotatably disposed on an upper end portion of the lift member 50a. The pushing-up roller 53 is rotatable and movable along a guide portion (not shown) formed in a lower end portion of the support frame 40. Accordingly, friction between the support frame 40 and the lift member 50a when operating the moving-up/down mechanism 50 is reduced by the rotation of the pushing-up roller 53; therefore, smooth moving-up/down operation becomes possible. Besides, the pushing-up roller 53 is pushed by a coil spring 55 in a direction (upward direction of FIG. 14) to move apart from the shaft 50b.

When the shaft 50b of the right moving-up/down mechanism 50 is rotated in a clockwise direction and the shaft 50b of the left moving-up/down mechanism 50 is rotated in a counterclockwise direction from the state of FIG. 12, the lift members 50a laid down in the unit housing 45 rise in an outward direction (arrow B direction) and the pushing-up roller 53 moves to one end of the guide portion. In this way, the lift member 50a is changed from the horizontal state to the upright state (state of FIG. 13) and makes the support frame 40 and the carriage 31 ascend.

On the other hand, when the shaft 50b of the right moving-up/down mechanism 50 is rotated in the counterclockwise direction and the shaft 50b of the left moving-up/down mechanism 50 is rotated in the clockwise direction from the state of FIG. 13, the lift members 50a fall in an inward direction (arrow B′ direction) of the unit housing 45 and the pushing-up roller 53 moves to the other end of the guide portion. In this way, the lift member 50a is changed from the upright state to the horizontal state (state of FIG. 12) and makes the support frame 40 and the carriage 31 descend.

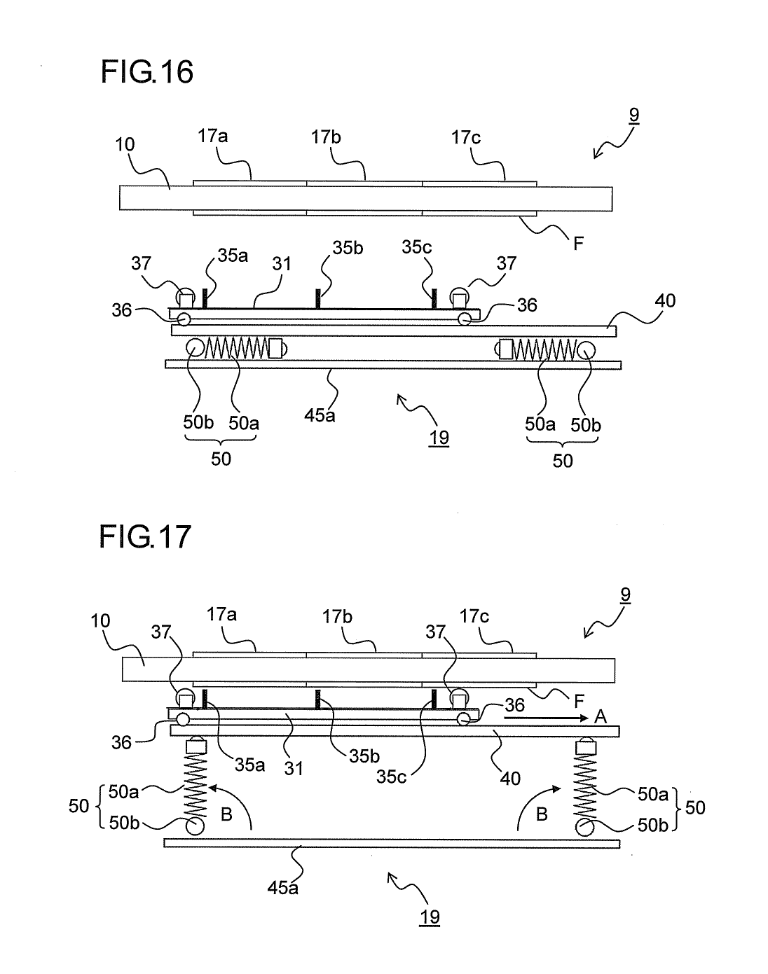

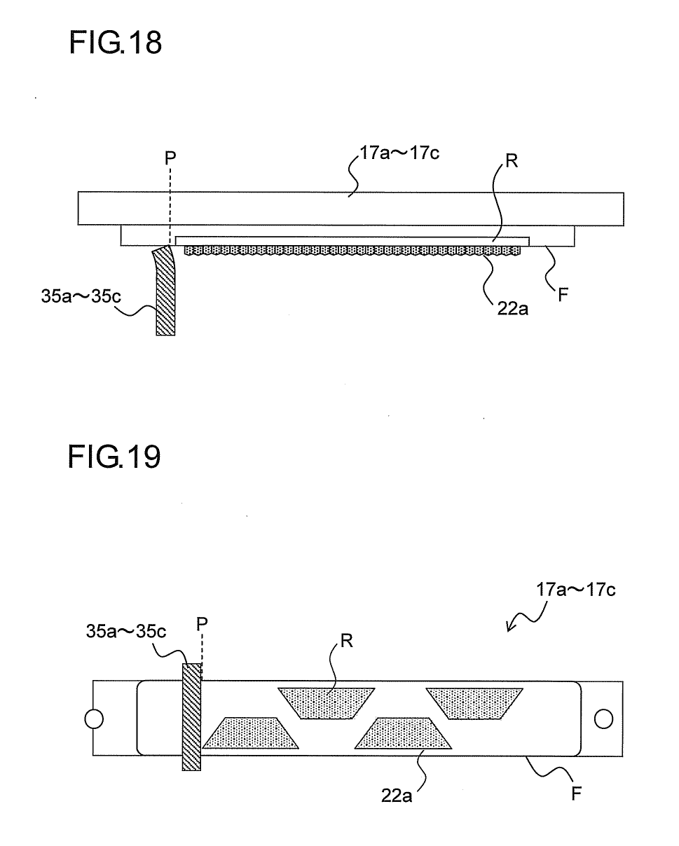

Next, recovery operation of the recording heads 17a-17c of the first embodiment, which uses the wiping mechanism 30 in the ink-jet recording apparatus 100 according to the present disclosure, is described. FIG. 15 is a view showing a state where the maintenance unit 19 is positioned under the recording portion 9, and FIG. 16 is a view showing a positional relationship between a set of the recording heads 17a-17c and a set of the wipers 35a-35c at a wiping operation start time. In the meantime, FIG. 16, and FIG. 17, FIG. 18, FIG. 23-FIG. 25 described later show a state when seeing the recording portion 9 and the maintenance unit 19 from the downstream side (left side of FIG. 15) in the paper-sheet conveyance direction. Besides, the support frame 40 is simplified to be shown as a plate shape, and only the bottom surface 45a of the unit housing 45 is shown. Besides, the recovery operation of the recording heads 17a-17c described hereinafter is performed by controlling the operation of the recording heads 17a-17c, wiping mechanism 30, moving-up/down mechanism 50 based on the control signal from the control portion 110 (see FIG. 1).

In a case where the recovery operation of the recording heads 17a-17c is performed, first, as shown in FIG. 15, the first conveyance unit 15 located under the recording portion 9 is made to descend. And, the maintenance unit 19 disposed under the second conveyance unit 12 is moved horizontally to be positioned between the recording portion 9 and the first conveyance unit 5. In this state, as shown in FIG. 16, the lift member 50a of the moving-up/down mechanism 50 is in the horizontal state, and the wipers 35a-35c fixed to the carriage 31 are positioned apart from the ink ejecting surface F of the recording heads 17a-17c.

(Purged Ink Placing Operation)

Prior to the wiping operation, the wipers 35a-35c are made to come into contact, by means of a predetermined pressure, with a stop position P (wiping start position) near an end portion of the nozzle region R of the ink ejecting surface F of the recording heads 17a-17c. Specifically, as shown in FIG. 17, the shaft 50b of the moving-up/down mechanism 50 is rotated to make the lift member 50a rise upright in the arrow B direction, whereby the support frame 40 and the carriage 31 are lifted. At this time, the gap rollers 37 disposed on the carriage 31 are pushed against a lower surface of the head housing 10 by the pushing force of the coil spring 55 (see FIG. 14) of the lift member 50a; accordingly, it is possible to push the wipers 35a-35c against the ink ejecting surface F at a constant pressure.

Next, the flow-in valve 27 (see FIG. 7) is closed and the syringe pump 21 (see FIG. 7) is pressured (the piston 21b is pushed down from the state of FIG. 7), whereby the ink 22 in the cylinder 21a is supplied to the recording heads 17a-17c via the second supply path 25. The supplied ink 22 is forcibly pushed out of the ink ejecting nozzles 18 (purge operation). The thickened ink, foreign matter, and air bubbles in the ink ejecting nozzles 18 are discharged by the purge operation, so that it is possible to recover the recording heads 17a-17c.

FIG. 18 and FIG. 19 are respectively a side view and plan view of the recording heads 17a-17c which show the state where the ink 22 is pushed out of the ink ejecting nozzles 18 with the wipers 35a-35c being opposite to the vicinity of the end portion of the nozzle region R. As show in FIG. 18, the wipers 35a-35c are pushed against the vicinity of an end portion (left end of FIG. 18 and FIG. 19) of the purged ink 22a pushed out of the ink ejecting nozzles 18 with a tip end bent. Besides, as shown in FIG. 19, the purged ink 22a is pushed out to the ink ejecting surface F along the shape of the nozzle region R where the ink ejecting nozzles 18 exists.

(Ejecting Wipe Operation)

The input gear 43 (see FIG. 8) is rotated forward to move the carriage 31 from the state in FIG. 18 and FIG. 19 in the arrow A direction of FIG. 17, whereby also the wipers 35a-35c supported by the carriage 31 move along the ink ejecting surface F in a direction (left to right direction of FIG. 18 and FIG. 19, hereinafter, called a first direction) of the nozzle region R. Upward forces by the moving-up/down mechanisms 50 act on the support frame 40; accordingly, the carriage 31 moves in the arrow A direction keeping the state where the gap roller 37 is pushed against the head housing 10.

During this period, the wipers 35a-35c successively pass the ink ejecting nozzles 18 (nozzle region R) and the ink is ejected from the ink ejecting nozzles 18 which the wipers 35a-35c are passing. And, the ink ejecting is successively performed in synchronization with timing when the wipers 35a-35c pass, while the wipers 35a-35c are moved to an end edge (right end edge of FIG. 18 and FIG. 19) of the ink ejecting surface F.

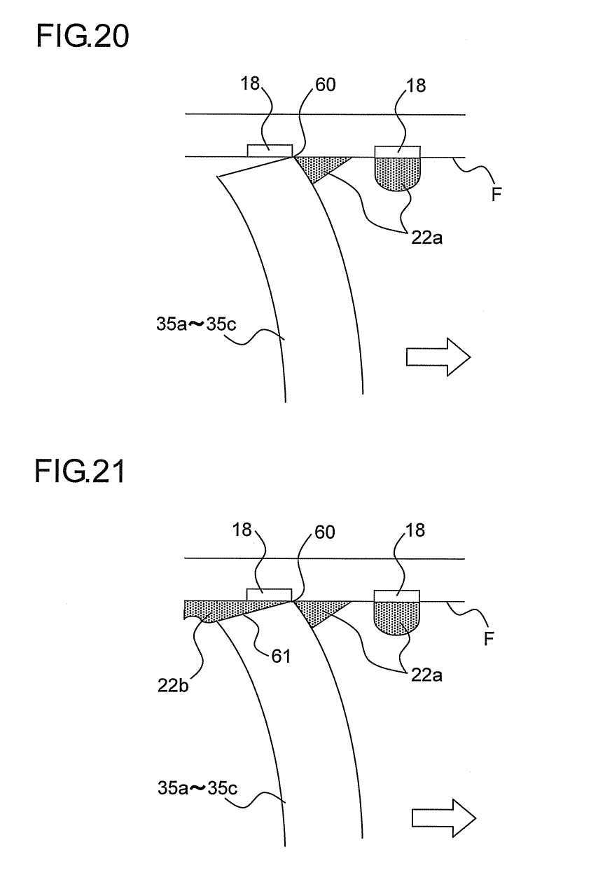

FIG. 20 is a view around the ink ejecting nozzle 18 which the wipers 35a-35c are passing, and FIG. 21 is a view showing the operation in which the ink is ejected from the ink ejecting nozzle 18 which the wipers 35a-35c are passing in FIG. 20. As shown in FIG. 20, the wipers 35a-35c pushed against the ink ejecting surface F move in the first direction (arrow direction) wiping away the purged ink 22a pushed out to the ink ejecting surface F by means of the edge portion 60 in the downstream side in the moving direction.

And, as shown in FIG. 21, at the timing when the wipers 35a-35c pass the ink ejecting nozzle 18 (in more detail, immediately after the edge portion 60 passes the ink ejecting nozzle 18), the ink is ejected from the ink ejecting nozzle 18. In this way, an ink puddle 22b is formed in a gap between an upper surface 61 of the wipers 35a-35c and the ink ejecting surface F.

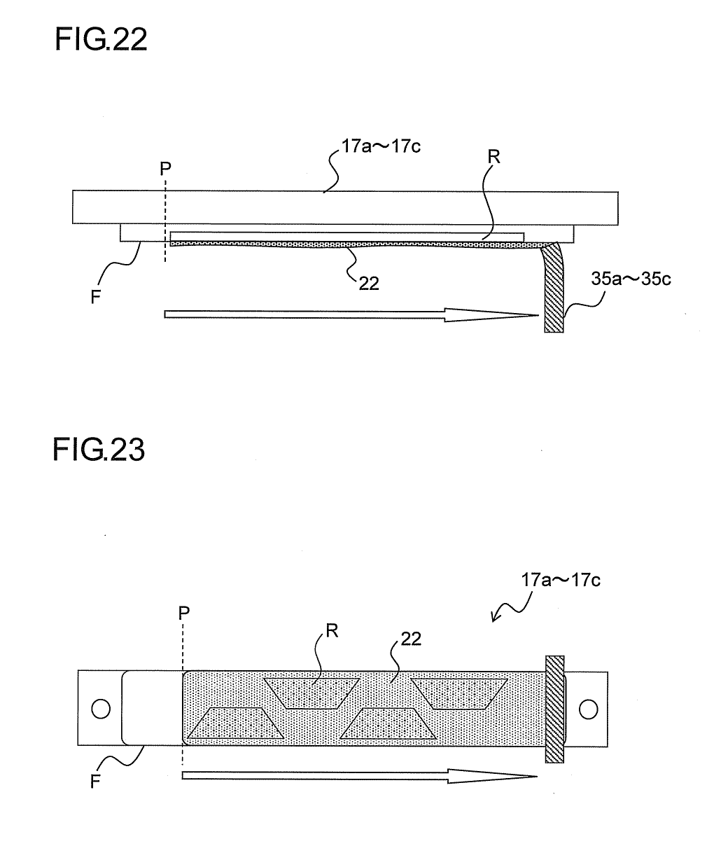

In the state of FIG. 21, the wipers 35a-35c move along the ink ejecting surface F, whereby the ink puddle 22b is spread; accordingly, as shown in FIG. 22 and FIG. 23, when the wipers 35a-35c move to the end edge (right end edge of FIG. 22 and FIG. 23) of the ink ejecting surface F, the ink 22 is evenly applied and spread over the entire ink ejecting surface F including the nozzle region R.

(Ink Wiping Operation)

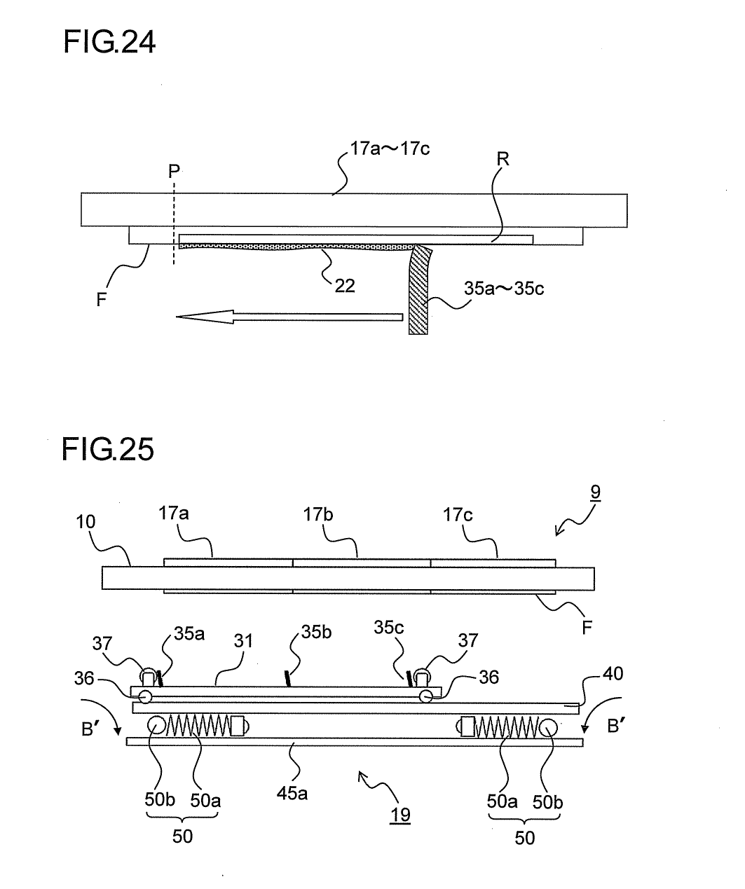

Thereafter, the wiping operation for wiping away the ink 22 applied and spread over the ink ejecting surface F is performed. The input gear 43 (see FIG. 8) is rotated backward from the state of FIG. 22 and FIG. 23 to move the carriage 31 in a direction (arrow A′ direction of FIG. 8) opposite to the arrow A of FIG. 17, whereby as shown in FIG. 24, also the wipers 35a-35c supported by the carriage 31 move along the ink ejecting surface F in a direction (right to left direction of FIG. 24, hereinafter, called a second direction) of the nozzle region R. In this way, the ink 22 applied and spread over the entire ink ejecting surface F is wiped away. The wasted ink wiped away by the wipers 35a-35c is collected into the ink collection tray 44 (see FIG. 10).

After the wipers 35a-35c move to an end edge (left end edge of FIG. 24) of the ink ejecting surface F of the recording heads 17a-17c, respectively, as shown in FIG. 25, the shaft 50b of the moving-up/down mechanism 50 is rotated to lay down the lift member 50a in the arrow B′ direction, whereby the wipers 35a-35c are separated downward from the ink ejecting surface F to return the maintenance unit 19 to the state of FIG. 16. Finally, the maintenance unit 19 positioned between the recording portion 9 and the first conveyance path 5 is moved horizontally to be disposed under the second conveyance unit 12, and the first conveyance unit 5 is moved to the predetermined position to end the recovery operation of the recording heads 17a-17c.

In a case where the cap unit 90 is mounted onto the recording heads 17a-17c, first, as shown in FIG. 15, the first belt conveyance portion 5 disposed to oppose a lower surface of the recording portion 9 is made to descend. And, the cap unit 90 disposed under the second belt conveyance portion 12 is moved horizontally into between the recording portion 9 and the first belt conveyance portion 5.

Next, the first belt conveyance portion 5 is made to ascend, whereby the cap unit 90 is pushed up. And, at a time when the cap unit 90 comes into tight contact with the recording heads 17a-17c, the ascent of the first belt conveyance portion 5 is stopped, whereby the mounting of the cap unit 90 onto the recording heads 17a-17c is completed.

In the structure of the present embodiment, after the purged ink placing operation, the ejecting wipe operation for moving the wipers 35a-35c to the end edge of the ink ejecting surface F with the wipers 35a-35c pushed against the ink ejecting surface F and for successively ejecting the ink from the ink electing nozzles 18 in synchronization with the timing when the wipers 35a-35c pass, whereby the ink 22 is applied and spread over the entire ink ejecting surface F. Accordingly, even in a case where the ink ejecting surface F is formed of a highly water-repellant material, it is possible to apply and spread the ink 22 over the ink ejecting surface F and to redisperse the foreign matter, such as mists, paper powder and the like that adhere to the portion other than the nozzle region R, into the ink 22 immediately after the ejecting.

Further, it is possible to perform the ejecting wipe operation and the ink wiping operation by only reciprocating the wipers 35a-35c along the ink ejecting surface F in the first direction and the second direction; accordingly, it is unnecessary to additionally dispose an applying member for applying and spreading the ink over the ink ejecting surface F and a drive mechanism for the applying member. Accordingly, without complicating the structure of the wiping mechanism 30, it is possible to effectively remove the foreign matter such as mists, paper powder and the like adhering to the ink ejecting surface F.

In the ejecting wipe operation, by keeping the ink puddle 22b, which is formed in the gap between the wipers 35a-35c and the ink ejecting surface F, in contact with the ink ejecting surface F for as a long time as possible, it is possible to sufficiently redisperse the foreign matter, such as mists, paper powder and the like adhering to the ink ejecting surface F, into the ink 22. Because of this, it is preferable to increase the ink ejecting amount when forming the ink puddle 22 or to slow the moving speed of the wipers 35a-35c during the ejecting wipe operation.

The ink ejecting amount and moving speed of the wipers 35a-35c may be suitably set in accordance with physical properties of the ink 22, wipers 35a-35c, and ink ejecting surface F utilized and frequency of the recovery operation of the recording head 17; however, if the ink ejecting amount is increased, the ink amount used for operations other than the image recording increases, so that the maintenance cost of the ink-jet recording apparatus 100 rises. Because of this, it is more preferable to slow the moving speed of the wipers 35a-35c during the ejecting wipe operation. For example, it is preferable to make the moving speed of the wipers 35a-35c during the purging wipe process slower than the moving speed of the wipers 35a-35c during the ink wiping process.

Besides, in a case where the flow velocity of the ink 22 pushed out when the purged ink placing operation is performed, there is a risk that the ink 22 is pushed out of only the ink ejecting nozzles 18, from which the ink is easily pushed out (there is no clogging by thickened ink), in the nozzle region R and the ink 22 is not pushed out from all the ink ejecting nozzles 18 in the nozzle region R. Because of this, it is preferable to push out the ink 22 at a flow velocity (e.g., 0.15 cc/sec or more, preferably 0.20 cc/sec or more) at which the ink 22 is evenly pushed out of the entire nozzle region R.

Besides, in a case where a large amount of foreign matter such as mists, paper powder and the like adheres to the ink ejecting surface F, the ink wiping operation is performed after performing repeatedly the ejecting wipe operation a plurality of times, or two or more cycles of the ejecting wipe operation and the ink wiping operation are performed, in one cycle of which the ejecting wipe operation and the ink wiping operation are each performed one time, whereby it is possible to secure a re-dispersion time for the foreign matter and expect a higher foreign matter removal effect.

Next, recovery operation of the recording heads 17a-17c of a second embodiment, which uses the wiping mechanism 30 in the ink-jet recording apparatus 100 according to the present disclosure, is described. Hereinafter, the purging wipe process, which is a characterizing portion of the present embodiment, is chiefly described. The movement of the maintenance unit 19 which is performed prior to the recovery operation of the recording heads 17a-17c, the purged ink placing operation, the ink wiping operation, and the mounting of the cap unit 90, are the same as the first embodiment; accordingly, description of them is skipped.

(Purging Wipe Operation)

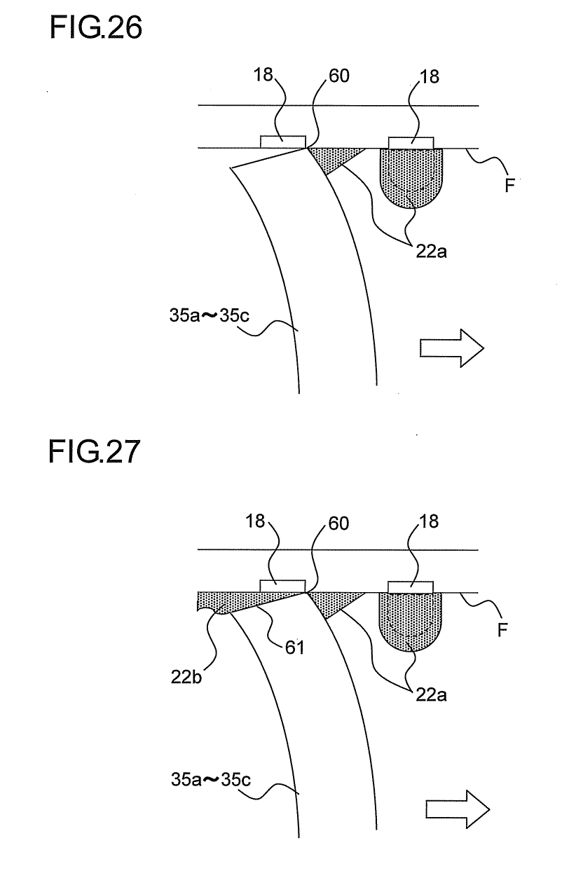

FIG. 26 is a view around then ink ejecting nozzle 18 which the wipers 35a-35c are passing during the recovery operation of the recording heads 17a-17c according to the second embodiment, and FIG. 27 is a view showing the operation in which the ink is ejected from the ink ejecting nozzle 18 which the wipers 35a-35c are passing in FIG. 26. As shown in FIG. 26, the wipers 35a-35c pushed against the ink ejecting surface F move in the first direction (arrow direction) while wiping away the purged ink 22a pushed out to the ink ejecting surface F by means of the edge portion 60 in the downstream side in the moving direction.

And, as shown in FIG. 27, when the wipers 35a-35c are passing any one of the nozzle regions R, the ink pushing-out (purge) is performed from all the ink ejecting nozzles 18 in each nozzle region R. In this way, the ink puddle 22b is formed in the gap between the upper end surface 61 of the wipers 35a-35c and the ink ejecting surface F. In the meantime, the ink pushing-out is performed from the ink ejecting nozzle 18 as well which the wipers 35a-35c have not passed yet; accordingly, the purged ink 22a is larger than the size (represented by a broken line in FIG. 26 and FIG. 27) of an ink drop after the ink ejecting process ends.

In the state of FIG. 27, the wipers 35a-35c move along the ink ejecting surface F, whereby the ink puddle 22b is spread; accordingly, as shown in FIG. 22 and FIG. 23 of the first embodiment, when the wipers 35a-35c move to the end edge (right end edge of FIG. 22 and FIG. 23) of the ink ejecting surface F, the ink 22 is evenly applied and spread over the entire ink ejecting surface F including the nozzle region R.

In the structure of the present embodiment, after the purged ink placing operation, the purging wipe operation is performed, in which the wipers 35a-35c are moved to the end edge of the ink ejecting surface F with the wipers 35a-35c pushed against the ink ejecting surface F; and the ink is pushed out of all the ink ejecting nozzles 18 in each nozzle region R when the wipers 35a-35c are passing any one of the nozzle regions R, whereby the ink 22 is applied and spread over the ink ejecting surface F. Accordingly, even in a case where the ink ejecting surface F is formed of a highly water-repellant material, it is possible to apply and spread the ink 22 and to redisperse again the foreign matter, such as mists, paper powder and the like that adhere to the portion other than the nozzle region R, into the ink 22 immediately after the pushing-out.

Besides, when the wipers 35a-35c are moving in the first direction during the purging wipe operation, the ink 22 is pushed out continuously or intermittently from the ink ejecting nozzles 18 as well which the wipers 35a-35c have not passed; accordingly, as shown in FIG. 26 and FIG. 27, the ink drop of the purged ink 22a wiped away by the wipers 35a-35c becomes large. As a result of this, the amount of ink coming into contact with the wipers 35a-35c increases; accordingly, it is easy to redisperse dirt, such as ink that adhere to the wipers 35a-35c and dry, foreign matter and the like, into the purged ink 22a and remove the dirt.

Besides, the ink 22 is pushed out continuously or intermittently from the ink ejecting nozzle 18 as well which the wipers 35a-35c have passed already; accordingly, the ink 22 pushed out of the ink ejecting nozzle 18 is further added to the ink puddle 22b spread by the wipers 35a-35c. Accordingly, it is possible to supply the ink 22 more evenly and sufficiently to the entire ink ejecting surface F.

Besides, the present disclosure is not limited to each of the above embodiments, and various modifications are possible without departing from the spirit of the present disclosure. For example, in each of the above embodiments, the ejecting wipe operation (or the purging wipe operation) and the ink wiping operation are performed by reciprocating the wipers 35a-35c in the first direction and the second direction; however, after the completion of the ejecting wipe operation (or the purging wipe operation), the wipers 35a-35c are moved away from the ink ejecting surface F and the carriage 31 is moved in the arrow A′ direction, thereafter, the wipers 35a-35c are moved in the first direction with the wipers 35a-35c pushed again against the stop position P, whereby the ink wiping operation may be performed.

Besides, as to the drive mechanism for the carriage 31 that is composed of the rack teeth 38, input gear 43 and moving-up/down mechanism 50, another conventionally known drive mechanism is usable. It is possible to suitably set the number of ink ejecting nozzles 18 of the recording heads 17a-17c, the interval of the nozzles and the like in accordance with the specifications of the ink-jet recording apparatus 100. Besides, also the number of recording heads is not limited, and for example, it is possible to dispose one recording head 17, two recording heads 17, or four or more recording heads 17 for each of the line heads 11C-11K.

Besides, the present disclosure is also applicable to an ink-jet recording apparatus for single color printing that includes any and only one of the line heads 11C-11K. In this case, one of the recording heads 17a-17c is disposed; accordingly, also the wipers 35a-35c corresponding to the recording heads 17a-17c may be fixed to the carriage 31 by one. Hereinafter, effects of the present disclosure is described in more detail by means of examples.

### Example 1

In the case where the recovery operation of the recording heads 17a-17c of the first embodiment is performed, difference between ink spreading effects is investigated by changing the linear velocity (moving speed) of the wipers 35a-35c during the ejecting wipe operation and the ejected ink amount from the ink ejecting nozzle 18 which the wipers 35a-35c are passing. First, a test apparatus is prepared, in which as the wipers 35a-35c, a rubber blade made of EPDM (Asker hardness: 60, impact resilience: about 60%) of 30 mm wide, 7 mm tall (protrusion amount) and 1.5 mm thick is mounted on the carriage 31 that reciprocates along the ink ejecting surface F of the recording heads 17a-17c and moves in a direction to come close to or go away from the ink ejecting surface F.

The dot forming portion of the recording heads 17a-17c has the structure shown in FIG. 6, in which the pressurization chamber 75 has an area of 0.2 mm², a width of 200 μm, and a depth of 100 μm; the nozzle flow path 76 has a diameter of 200 μm and a length of 800 μm; the supply hole 79 has a diameter of 30 μm and a length of 40 μm; the ink ejecting nozzle 18 has a length of 30 μm; and the shape of the ejecting opening 18a is a circle with a radius of 10 μm. A recording head is prepared, in which the dot forming portions having the above structure to the number of 166 are arranged in one line on the ink ejecting surface F, and to the number of 664 are arranged in total (four lines). The ink ejecting nozzles 18 in the same line have a pitch of 150 dpi, besides, adjacent lines are deviated by ¼ pitch to obtain 600 dpi in total.

Besides, the ink 22 utilized is water-based ink that has a composition shown in FIG. 1; each component is sufficiently stirred, thereafter, is filtered with pressure by means of a filter having a hole diameter of 5 μm to obtain the ink 22.

TABLE 1

| | blending quantity |
|---|---|
| material | [wt %] |
| pigment dispersion | 25.0 |
| olefin | 0.5 |
| 1,3-butanediol | 5.0 |
| triethylene glycol monobutyl ether | 5.0 |
| 2-pirrolidone | 5.0 |
| glycerin | 15.0 |
| ion exchange water | 44.5 |
| total | 100.0 |

And, the overlap amount between the wipers 35a-35c and the ink ejecting surface F is set at 1 mm, and the wipers 35a-35c are pushed against the highly water-repellant ink ejecting surface F; by changing the linear velocity of the wipers 35a-35c and the ejected ink amount from the ink ejecting nozzles 18 which the wipers 35a-35c are passing to perform the ejecting wipe operation, spreading effects of the ink 22 at a rear end of the wipers 35a-35c are visually observed. The results are shown in the table 2. In the table 2, a case, where the spreading of the ink 22 occurs at the rear end of the wipers 35a-35c, is indicated ∘, and a case, where the spreading of the ink 22 does not occur, is indicated x.

TABLE 2

| | | ejecting amount per one nozzle(×10⁻⁴ cc) | | | | | | |
|---|---|---|---|---|---|---|---|---|
| | | 1.0 | 3.0 | 5.0 | 7.0 | 10.0 | 15.0 | 20.0 |
| wiper linear | 10 | x | x | x | ∘ | ∘ | ∘ | ∘ |
| velocity | 20 | x | x | x | ∘ | ∘ | ∘ | ∘ |
| (mm/sec) | 30 | x | x | x | x | ∘ | ∘ | ∘ |
| | 50 | x | x | x | x | ∘ | ∘ | ∘ |
| | 100 | x | x | x | x | x | x | ∘ |

As is clear from the table 2, when the wipers 35a-35c have linear velocities of 10 mm/sec or 20 mm/sec, a spreading effect is recognized at a ejected ink amount of 7.0×10⁻⁴ cc or more per one ink ejecting nozzle. Besides, when the wipers 35a-35c have linear velocities of 30 mm/sec or 50 mm/sec, a spreading effect is recognized at a ejected ink amount of 10.0×10⁻⁴ cc or more per one ink ejecting nozzle, and when the wipers 35a-35c have a linear velocity of 100 mm/sec, a spreading effect is recognized at a ejected ink amount of 20.0×10⁻⁴ cc or more per one ink ejecting nozzle. In other words, it is understood that during the ejecting wipe operation, the slower the linear velocity of the wipers 35a-35c becomes and the more the ejected amount of the ink 22 becomes, the higher the spreading effect of the ink 22 becomes.

### Example 2

In the case where the recovery operation of the recording heads 17a-17c of the first embodiment is performed, difference between mist removal effects is investigated by changing the linear velocity (moving speed) of the wipers 35a-35c during the ejecting wipe operation and the ejected ink amount from the ink ejecting nozzle 18 which the wipers 35a-35c are passing. The structures of the recording heads 17a-17c and wipers 35a-35c and the composition of the ink 22 are the same as the example 1.

As a test method, mists are placed and dried on the highly water-repellant ink ejecting surface F; thereafter, by changing the linear velocity of the wipers 35a-35c and the ejected ink amount from the ink ejecting nozzle 18 which the wipers 35a-35c are passing to perform the ejecting wipe operation and the ink wiping operation, wiping-away degrees of the mists adhering to the ink ejecting surface F are observed. As an evaluation method, executing each of the ejecting wipe operation and the ink wiping operation one time is defined one cycle, and a case where the mists are wiped away in one cycle is indicated ∘; a case where the mists are wiped away in two cycles is indicated Δ; and a case where the mists are wiped away in three or more cycles is indicated x. The results are shown in the table 3.

TABLE 3

| | | ejecting amount per one nozzle(×10⁻⁴ cc) | | | | | | |
|---|---|---|---|---|---|---|---|---|
| | | 1.0 | 3.0 | 5.0 | 7.0 | 10.0 | 15.0 | 20.0 |
| wiper linear | 10 | x | x | Δ | ∘ | ∘ | ∘ | ∘ |
| velocity | 20 | x | x | x | ∘ | ∘ | ∘ | ∘ |
| (mm/sec) | 30 | x | x | x | Δ | ∘ | ∘ | ∘ |
| | 50 | x | x | x | x | ∘ | ∘ | ∘ |
| | 100 | x | x | x | x | x | Δ | ∘ |

As is clear from the table 3, when the wipers 35a-35c have linear velocities of 10 mm/sec or 20 mm/sec, the mists are wiped away in one cycle at a ejected ink amount of 7.0×10⁻⁴ cc or more per one ink ejecting nozzle. Besides, when the wipers 35a-35c have linear velocities of 30 mm/sec or 50 mm/sec, the mists are wiped away in one cycle at a ejected ink amount of 10.0×10⁻⁴ cc or more per one ink ejecting nozzle, and when the wipers 35a-35c have a linear velocity of 100 mm/sec, the mists are wiped away in one cycle at a ejected ink amount of 20.0×10⁻⁴ cc per one ink ejecting nozzle. In other words, it is understood that during the ejecting wipe operation, the slower the linear velocity of the wipers 35a-35c becomes and the more the ejected amount of the ink 22 becomes, the higher the mist wiping effect becomes.

### Example 3

In the case where the recovery operation of the recording heads 17a-17c of the second embodiment is performed, difference between ink spreading effects is investigated by changing the linear velocity (moving speed) of the wipers 35a-35c during the purging wipe operation and the flow velocity (flow velocity of the ink that flows in the second supply path 25 when the piston 21b of FIG. 7 is pushed down) of the ink pushed out of the ink ejecting nozzles 18 which the wipers 35a-35c are passing. The structures of the recording heads 17a-17c and wipers 35a-35c and the composition of the ink 22 are the same as the examples 1 and 2.

And, the overlap amount between the wipers 35a-35c and the ink ejecting surface F is set at 1 mm, and the wipers 35a-35c are pushed against the highly water-repellant ink ejecting surface F; by changing the linear velocity of the wipers 35a-35c and the flow velocity of the ink pushed out of the ink ejecting nozzles 18 which the wipers 35a-35c are passing to perform the purging wipe operation, spreading effects of the ink 22 at the rear end of the wipers 35a-35c are visually observed. The results are shown in the table 4. In the table 4, a case, where the spreading of the ink 22 occurs at the rear end of the wipers 35a-35c, is indicated ∘, and a case, where the spreading of the ink 22 does not occur, is indicated x.

TABLE 4

| | | flow velocity(cc/sec) | | | | | | |
|---|---|---|---|---|---|---|---|---|
| | | 0.10 | 0.20 | 0.30 | 0.50 | 0.80 | 1.00 | 2.00 |
| wiper linear | 10 | x | ∘ | ∘ | ∘ | ∘ | ∘ | ∘ |
| velocity | 20 | x | x | x | ∘ | ∘ | ∘ | ∘ |
| (mm/sec) | 30 | x | x | x | x | ∘ | ∘ | ∘ |
| | 50 | x | x | x | x | ∘ | ∘ | ∘ |
| | 100 | x | x | x | x | x | x | ∘ |

As is clear from the table 4, when the wipers 35a-35c have a linear velocity of 10 mm/sec, a spreading effect is recognized at a flow velocity of 0.2 cc/sec or more of the ink pushed out. When the wipers 35a-35c have a linear velocity of 20 mm/sec, a spreading effect is recognized at a flow velocity of 0.5 cc/sec or more of the ink pushed out. Besides, when the wipers 35a-35c have linear velocities of 30 mm/sec or 50 mm/sec, a spreading effect is recognized at a flow velocity of 0.80 cc/sec or more of the ink pushed out, and when the wipers 35a-35c have a linear velocity of 100 mm/sec, a spreading effect is recognized at a flow velocity of 2.00 cc/sec of the ink pushed out. In other words, it is understood that during the purging wipe operation, the slower the linear velocity of the wipers 35a-35c becomes and the more the pushed-out amount of the ink 22 becomes, the higher the spreading effect of the ink 22 becomes.

### Example 4

In the case where the recovery operation of the recording heads 17a-17c of the second embodiment is performed, difference between mist removal effects is investigated by changing the linear velocity (moving speed) of the wipers 35a-35c during the purging wipe operation and the flow velocity of ink pushed out of the ink ejecting nozzles 18 which the wipers 35a-35c are passing. The structures of the recording heads 17a-17c and wipers 35a-35c and the composition of the ink 22 are the same as the example 1-3.

As a test method, mists are placed and dried on the highly water-repellant ink ejecting surface F; thereafter, by performing the purging wipe operation changing, in a stepwise manner, the linear velocity of the wipers 35a-35c and the pushed-out ink amount from the ink ejecting nozzles 18 which the wipers 35a-35c are passing and by performing the ink wiping operation at a linear velocity of 50 mm/sec of the wipers 35a-35c, wiping-away degrees of the mists adhering to the ink ejecting surface F are observed. As an evaluation method, executing each of the purging wipe operation and the ink wiping operation one time is defined one cycle, and a case where the mists are wiped away in one cycle is indicated ∘; a case where the mists are wiped away in two cycles is indicated A; and a case where the mists are wiped away in three or more cycles is indicated x. The results are shown in the table 5.

TABLE 5

| | | flow velocity(cc/sec) | | | | | | |
|---|---|---|---|---|---|---|---|---|
| | | 0.10 | 0.20 | 0.30 | 0.50 | 0.80 | 1.00 | 2.00 |
| wiper linear | 10 | Δ | ∘ | ∘ | ∘ | ∘ | ∘ | ∘ |
| velocity | 20 | x | Δ | Δ | ∘ | ∘ | ∘ | ∘ |
| (mm/sec) | 30 | x | x | Δ | Δ | ∘ | ∘ | ∘ |
| | 50 | x | x | x | Δ | ∘ | ∘ | ∘ |
| | 100 | x | x | x | x | Δ | Δ | ∘ |

As is clear from the table 5, when the wipers 35a-35c have a linear velocity of 10 mm/sec, a spreading effect is recognized at a flow velocity of 0.2 cc/sec or more of the ink pushed out. When the wipers 35a-35c have a linear velocity of 20 mm/sec, a spreading effect is recognized at a flow velocity of 0.5 cc/sec or more of the ink pushed out. Besides, when the wipers 35a-35c have linear velocities of 30 mm/sec or 50 mm/sec, the mists are wiped away in one cycle at a flow velocity of 0.80 cc/sec or more of the ink pushed out, and when the wipers 35a-35c have a linear velocity of 100 mm/sec, the mists are wiped away in one cycle at a flow velocity of 2.00 cc/sec of the ink pushed out. In other words, it is understood that during the purging wipe operation, the slower the linear velocity of the wipers 35a-35c becomes and the faster the flow velocity of the ink 22 pushed out becomes, the higher the mist wiping effect becomes.

From the above results, to minimize the ink consumption amount as less as possible and obtain a stable mist removal effect, it is confirmed preferable to make the linear velocity of the wipers 35a-35c as slow as possible during the purging wipe operation.

The present disclosure is usable for an ink-jet recording apparatus that performs recording by ejecting ink from a recording head. By using the present disclosure, an ink-jet recording apparatus including a recording-head recovery system is obtained, in which it is possible to surely remove the foreign matter such as mists, paper powder and the like that adhere to an ink ejecting surface of the recording head; and it is possible to effectively minimize defective ink ejecting and a decline in sealability when a cap is mounted.

What is claimed is:

1. A recording-head recovery system comprising:
a wiper that is pushed against a wiping start position outside a nozzle region of a recording head, the nozzle region being provided with an ejecting nozzle that ejects ink onto a recording medium;
a drive mechanism that reciprocates the wiper along an ink ejecting surface including the nozzle region; and
a control portion that controls pushing-out and ejecting of the ink from the ejecting nozzle and operation of the drive mechanism; wherein
the control portion successively performs: a purged ink placing operation in which the ink is forcibly pushed out of the ejecting nozzle and the purged ink is placed onto the nozzle region; a ejecting wipe operation in which the wiper is moved from the wiping start position along the ink ejecting surface to wipe away the purged ink, and the ink ejecting from the ejecting nozzle is successively performed in synchronization with timing when the wiper passes to apply and spread the ink over the ink ejecting surface; and an ink wiping operation in which the wiper is moved along the ink ejecting surface to wipe away the purged ink applied and spread over the ink ejecting surface.

2. The recording-head recovery system according to claim 1, wherein
a moving speed of the wiper during the ejecting wipe operation is slower than a moving speed of the wiper during the ink wiping operation.

3. The recording-head recovery system according to claim 1, wherein
the ejecting wipe operation is repeatedly performed a plurality of times, thereafter, the ink wiping operation is performed.

4. The recording-head recovery system according to claim 1, wherein
performing each of the ejecting wipe operation and the ink wiping operation one time is defined one cycle, and the ejecting wipe operation and the ink wiping operation are performed two or more cycles.

5. The recording-head recovery system according to claim 1, wherein
the ejecting wipe operation is performed by moving the wiper in a first direction from the wiping start position to the nozzle region, while the ink wiping operation is performed by moving the wiper in a second direction opposite to the first direction after the ejecting wipe operation is performed.

6. An ink-jet recording apparatus comprising the recording-head recovery system according to claim 1.

7. A recording-head recovery system comprising:
a wiper that is pushed against a wiping star position outside a nozzle region of a recording head, the nozzle region being provided with an ejecting nozzle that ejects ink onto a recording medium;
a drive mechanism that reciprocates the wiper along an ink ejecting surface including the nozzle region; and
a control portion that controls pushing-out and ejecting of the ink from the ejecting nozzle and operation of the drive mechanism; wherein
the control portion successively performs: a purged ink placing operation in which the ink is forcibly pushed out of the ejecting nozzle and the purged ink is placed onto the nozzle region; a purging wipe operation in which the wiper is moved from the wiping start position along the ink ejecting surface to wipe away the purged ink, and the ink is continuously or intermittently pushed out of the ejecting nozzle in at least a downstream side in a moving direction of the wiper in the nozzle region when the wiper is passing the nozzle region, whereby the ink is applied and spread over the ink ejecting surface; and an ink wiping operation in which the wiper is moved along the ink ejecting surface to wipe away the purged ink applied and spread over the ink ejecting surface.

8. The recording-head recovery system according to claim 7, wherein
a moving speed of the wiper during the purging wipe operation is slower than a moving speed of the wiper during the ink wiping operation.

9. The recording-head recovery system according to claim 7, wherein
the purging wipe operation is repeatedly performed a plurality of times, thereafter, the ink wiping operation is performed.

10. The recording-head recovery system according to claim 7, wherein
performing each of the purging wipe operation and the ink wiping operation one time is defined one cycle, and the purging wipe operation and the ink wiping operation are performed two or more cycles.

11. The recording-head recovery system according to claim 7, wherein
the purging wipe operation is performed by moving the wiper in a first direction from the wiping start position to the nozzle region, while the ink wiping operation is performed by moving the wiper in a second direction opposite to the first direction after the purging wipe operation is performed.

12. An ink-jet recording apparatus comprising the recording-head recovery system according to claim 7.

13. A recording-head recovery method comprising:
a purged ink placing step for forcibly pushing out ink from an ejecting nozzle of a recording head and placing the purged ink onto a nozzle region, the recording head being provided with the nozzle region to which the ejecting nozzle for ejecting the ink onto a recording medium is opened;
an ejecting wipe step for after performing the purged ink placing step, wiping away the purged ink by moving a wiper along a ink ejecting surface including the nozzle region with the wiper being kept in contact with a wiping start position outside the nozzle region, applying and spreading the ink over the ink ejecting surface by successively performing the ink ejecting from the ejecting nozzle in synchronization with timing when the wiper passes; and
an ink wiping step for after performing the ejecting wipe step, for wiping away the ejected ink applied and spread over the ink ejecting surface by moving the wiper along the ink ejecting surface.
